(19) United States
(12) Patent Application Publication
(10) Pub. No.: US 2006/0051072 A1
(43) Pub. Date: Mar. 9, 2006

(54) System and method for creating a high definition visual effecti from mpeg-2 mp@ml compressed video

(75) Inventors: Lilla Boroczky, Mount Kisco, NY (US); Tse-Hua John Lan, Smyrna, GA (US)

Correspondence Address: PHILIPS INTELLECTUAL PROPERTY & STANDARDS, P.O. BOX 3001, BRIARCLIFF MANOR, NY, 10510, US

(73) Assignee: koninklijke Philips Electronics N.V.

(21) Appl. No.: 10/538,116

(22) PCT Filed: Dec. 3, 2003
(86) PCT No.: PCT/IB03/05595

§ 371 Date: Jun. 8, 2005

Related U.S. Application Data
(60) Provisional application No. 60/432,304, filed on Dec. 10, 2002.

(51) Int. Cl. H04N 5/781

(52) U.S. Cl. 386/125; 386/131

(57) ABSTRACT

A system and method for recording and reconstructing a high definition video on a standard definition compatible medium (e.g., a DVD). A recording system is provided that comprises: a system for scaling down the HD video images to an SD video format; a system for encoding the SD video; a system for generating a fine detail map for each HD video image; and a system for storing the SD video and the fine detail map onto the SD compatible medium.

The present invention relates generally to systems for recording and playing back digital image data, and more particularly relates to a system and method for recording high definition material on a standard definition compatible medium (e.g., a DVD) so that the medium can be played back in either a standard or high definition mode.

With the growing popularity of digital video, digital video applications, including DVDs (digital versatile disks), digital video recorders, digital video transmissions, home networking, high definition TIVO®, etc., have become more standardized. For example, DVD players and DVD recorders provide standardized formats to achieve an easy and affordable method for recording and playing digital videos. Various standardized formats exist for recording digital video information, including MPEG-2, etc.

One of the issues for digital video applications that has yet to be adequately addressed relates to the increasing popularity of high definition (HD) material. Presently, there is no set format for using a standard definition (SD) format for recording and playing back high definition (HD) material. For instance, no standard format exists for recording high definition material on a 4.7 GB single sided DVD, (referred to herein as HD-on-SD-DVD). This issue will only become more important as 2006 approaches, which is when the Advanced Television Systems Committee (ATSC) has mandated that high definition broadcasts become the standard for U.S. television channels.

Based on the above, it can be seen that recording HD video in a standard format (whether for DVD applications, other digital recording applications, video transmissions or broadcast applications) will become an important option for digital systems and open new markets for consumer electronics, semiconductors, film industries, etc. Furthermore, techniques for providing HD-on-SD-DVD will become useful for other applications and mediums that support long play mode recording, such as HD-DVD recorders or hard-disk based recorders.

Accordingly, a need exists for a system that can provide HD material in a SD compatible format, such as an SD-DVD.

The present invention addresses the above-mentioned issues, as well as others, by providing a system and method for providing HD recording and playback systems that provide an HD feel on an up-converted SD image using enhancement information extracted from the original HD image during recording.

In a first aspect, the invention provides a recording system for recording high definition (HD) video images in a standard definition (SD) compatible format, comprising: a system for scaling down the HD video images to an SD video format; a system for encoding the SD video; a system for generating a fine detail map for each HD video image; and a system for storing the SD video and the fine detail map in the SD compatible format.

In a second aspect, the invention provides a playback system for reconstructing a high definition (HD) video image from a standard definition (SD) format bitstream, comprising: a system for extracting and decoding SD data from the bitstream; a system for extracting a fine detail map associated with each image from the bitstream; a system for de-interlacing the decoded SD data; and a system for up-scaling and post-processing the decoded SD data with the fine detail map to generate the HD video image.

In a third aspect, the invention provides a method for recording high definition (HD) video images onto a standard definition (SD) compatible medium, comprising: scaling down the HD video images to an SD video format; encoding the SD video; generating a fine detail map from each HD video image, wherein the fine detail map identifies edge details in each image; and storing the SD video and the fine detail map onto the SD compatible medium.

In a fourth aspect, the invention provides a method of reconstructing a high definition (HD) video image from a standard definition (SD) format recording, comprising: extracting and decoding SD data from the recording; extracting a fine detail map from the recording, wherein the fine detail map identifies edge details; de-interlacing the decoded SD data; and up-scaling and post-processing the decoded SD data with the fine detail map to generate the HD video image.

In a fifth aspect, the invention provides a program product stored on a recordable medium for generating a fine detail map to allow (HD) video images to be stored and played back from a standard definition (SD) medium, comprising: means for extracting high frequency image data from a HD video image; means for creating a threshold map having threshold values derived from a brightness level and an activity level of each region in the HD video image; and means for comparing the threshold values to corresponding high frequency image data.

These and other features of this invention will be more readily understood from the following detailed description of the various aspects of the invention taken in conjunction with the accompanying drawings in which:

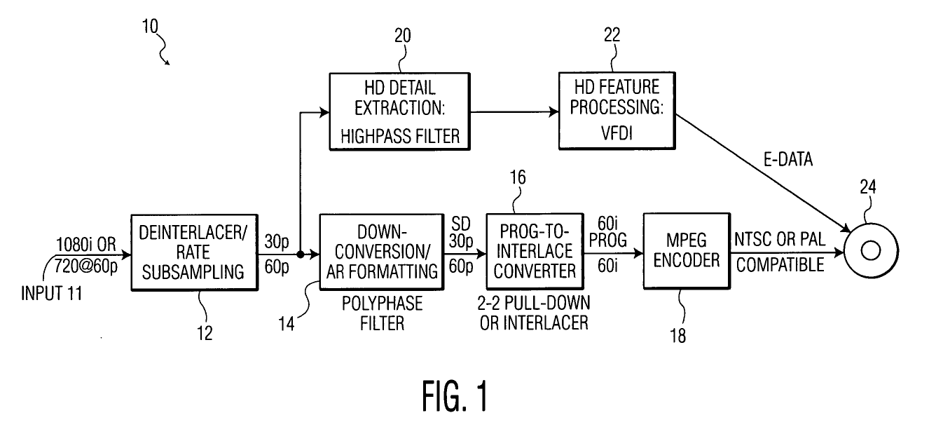

FIG. 1 depicts a recording system in accordance with the present invention.

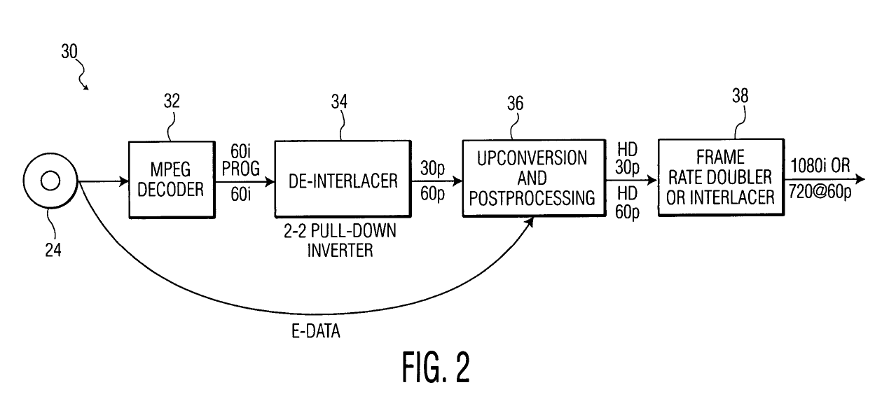

FIG. 2 depicts a playback system in accordance with the present invention.

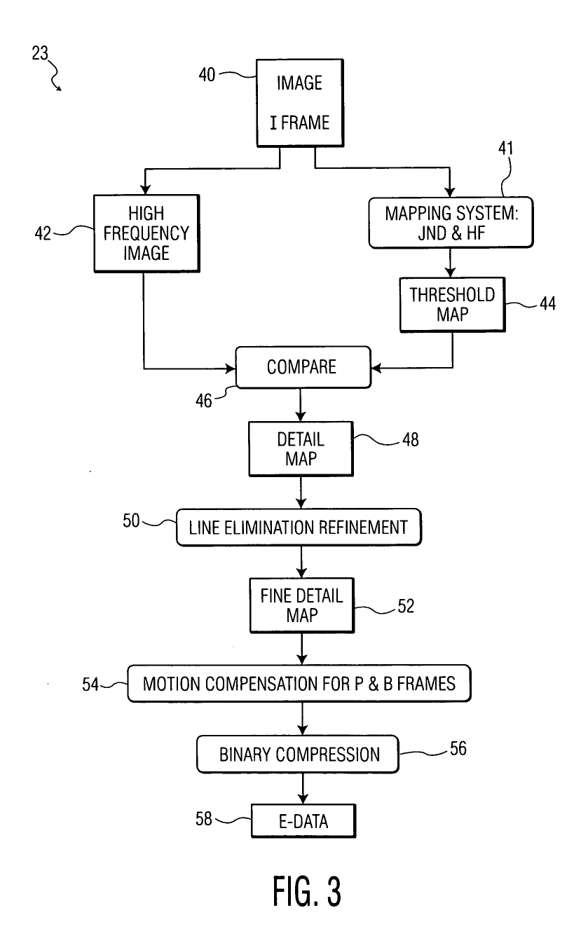

FIG. 3 depicts a visual-based fine detail injection system in accordance with the present invention.

1. Overview

The present invention provides a video processing system and method that can record HD material in an SD compatible format (e.g., SD-DVD) in a manner such that the SD compatible medium can be played back in a regular SD player for regular SD viewing, or in an HD enabled SD player for HD viewing. More particularly, the invention presents a novel method to encode HD video at low bitrates (˜5 Mbps) using the MPEG-2 Main Profile@Main Level standard (in order to be compatible with current digital video devices; e.g., DVD players, digital video recorders, transmission media, etc.) with embedded HD-relevant information (E-data) in the bitstream. It should be recognized that while the embodiments described herein are generally directed to a DVD system, the invention is not limited to a specific system or medium; rather the invention could be applied to any type of digital recording, transmission and/or playback system, and for example, use any type of writable/re-writable medium (e.g., DVD-R, -RW, +RW, -RAM, transmission signal, digital tape, bitstream, etc.). Specifically, the invention can apply to any application capable of utilizing the MPEG-2 Main Profile@Main Level standard (MPEG-2 MP @ ML) format, or similar format, where:
(1) an HD video can be down-converted to an SD video, and E-data can be extracted, coded, and packaged with the SD video; and
(2) be displayed back in HD resolution enhanced using the E-data.
   Examples of such applications include, but are not limited to broadcasting, home networking, web transmissions, HD TIVO, personal video recorders, etc.

Using the techniques described herein, an exemplary system is provided that is able to record a two-hour “near” HD quality video in a 4.7 GByte DVD, or a four-hour near HD video in a 9 Gbyte DVD. As will be explained in further detail below, during recording, the system both: (1) converts the inputted HD signal into an SD signal; and (2) generates enhancement information from the HD signal. The system then encodes the SD signal, e.g., using an MPEG-2 encoder, and stores the enhancement information, e.g., in the userdata field of the MPEG bitstream.

The exemplary embodiments described herein utilize only a relatively small amount of enhancement information that captures important HD image features, namely, edge details collected relative to threshold values for the image. In this manner, a low bitrate can be used for the enhancement information (i.e., less than 1.0 Megabytes/second) and the combination of the SD signal and enhancement information can be maintained at approximately 5 Megabytes/second. Prior art approaches, such as MPEG-2 layered or scalable coding, could not maintain such a low bitrate to obtain a reasonable quality.

In the case of a DVD application, the recorded DVD is not only fully compatible to current DVD play back standards, but the DVD can also be played back in an HD enabled DVD player that uses the enhancement data to generate a “pseudo” HD quality video. As noted above, while the embodiments provided herein in FIGS. 1 and 2 describe the SD format output 24 as a DVD, it should be understood that any digital video application could be utilized.

2. Recording System

Referring now to FIG. 1, an exemplary recording system 10 in accordance with the present invention is shown. System 10 receives an HD input signal 11 and generates an SD format output 24. The input of the system may accept all ATSC formats either in bitstream form or in component-signal form (for the bitstream form, an HD MPEG-2 decoder would be required). However, for the purpose of explanation, system 10 is shown accepting 1080i (interlaced) and 720p (progressive) formats. Accordingly, the exemplary system is capable of processing two different formats, progressive and interlaced, both of which are compatible with current SD standards. The progressive format is noted as 30p or 60i prog(ressive) (similar to film mode), and they are in the upper part of flow arrows after the “prog-to-interlace-converter” block 16. Note that 60i prog is structurally the same as 30p, except that 60i prog is treated as the interlaced format. The reason for converting 30p to the 60i progressive format is to guarantee the compatibility of the recorded DVD for all the DVD players that support (re)writable DVDs. The interlaced format is noted as 60i, and it is in the lower part of the flow arrows.

The basic operation of the recording system 10 is as follows. The input pictures (i.e., video) are scaled down to SD pictures, and some important HD features or HD enhancement data (referred to herein as E-data) is extracted from the input. An MPEG-2 encoder then codes the SD sequences, and the MPEG-2 bitstream is saved in storage (e.g., DVD+RW) together with E-data. The E-data can, for example, be stored in the userdata field of the MPEG bitstream.

System 10 comprises a de-interlacer/rate subsampling system 12 that deinterlaces or subsamples the input signal 11 to 30p or 60p formats. Down-conversion/aspect ratio (AR) formatting system 14 then formats the signal with a wide screen, letterboxing, or expansion (pan and scan) aspect ratio format. Progressive-to-interlace converter 16 performs a 2-2 pull-down from 30p to 60i prog, or performs interlacing to convert 60p to 60i. MPEG encoder 18 then encodes the signal into an NTSC or PAL compatible format.

In addition, after the input signal is de-interlaced/subsampled, the signal is also passed to an HD detail extraction system 20, which extracts high frequency image data from the signal. The extraction may be accomplished with, for instance, a high pass filter or residual operator. The high frequency image data is then passed to an HD feature processing system 22 to generate HD enhancement information, or E-data. The E-data is then stored with the SD format output 24; for instance, in the userdata field of the MPEG encoded data.

For the purposes of this invention, it should be understood that no limitations exist on the type of E-data that may be generated and used. It is recognized however that high frequency image (HFI) data provides important detail information for edges, which is important in generating an HD image. Unfortunately, encoding an entire HFI image bit by bit would significantly increase the total bitrate, which must be kept to around 5 Mbps if, for example, a two hour video is to be stored on 4.7 Gbyte DVD. As a solution, the present exemplary embodiment proposes to include a select amount of fine detail information, i.e., E-data, with the SD data. Specifically, a visual-based fine detail injection (VFDI) system 23 is provided to generate a fine detail map that describes detail or enhancement values for regions (i.e., pixels, blocks, etc.) within each image. The enhancement values may, for example, identify the existence of edge details in an image, and reflect the importance of each edge relative to a set of threshold values. For instance, it is known that edge details located in the center of an image, near other edge details, tend to be critical for overall picture clarity. Accordingly, such edges could be given a relatively high enhancement value in the generated fine detail map, indicating that such locations should be enhanced.

VFDI system 23 is described in further detail with reference to flow diagram in FIG. 3. Initially, an image 40 comprising an I frame is processed to generate a high frequency image (HFI) 42. In general, the HFI 42 provides edge details from the original image 40, shown as “lines” throughout the HFI 42. For instance, if the original image 40 included a house and trees against a blue sky, the HFI 42 may appear as a “washed-out” version of the original image containing high frequency information in the form of: lines that detail where the edge of the house met the sky; lines detailing window frames; lines detailing tree contours, etc.

In addition, a threshold map 44 is generated from the image 40 by a mapping system 41. The threshold map 44 assigns values to different regions of the image 40. In general, the greater the need to enhance details for the region, the lower the threshold value. In one exemplary embodiment, the threshold map 44 is derived using the Just Noticeable Difference (JND) and Human Focus (HF) concepts, which are well known in the art. According to JND, details in dark and low activity areas of an image are more pronounced than those of the same magnitude in bright and high activity areas. Thus, dark and low activity areas are identified and assign a lower threshold relative to bright and high activity areas, so that more details will stand out. In practice, the threshold map 44 using JND can be computed by linearly combining the mean (representing the gray level) and the variance (representing the activity) of 8×8 blocks in the up-converted SD picture. In addition to JND, other factors can be utilized to influence the values in the threshold map 44. For example, it is known that the human focus (HF) usually concentrates on the center of a display. Accordingly, a lower threshold can be assigned to the center region of the image relative to the outer regions or periphery of the image. It should be understood that the embodiments described herein used to generate the threshold map 44 are for exemplary purposes only, and additional or different factors could be utilized.

Next, the HFI data 42 from the image 40 is compared 46 to the values from the threshold map 44 to generate a detail map 48. For instance, if an HFI value for a particular location (e.g., an edge) exceeds a threshold value in a corresponding location in the threshold map 44, the corresponding location in the detail map 48 will indicate that the location should receive an enhancement (i.e., a positive gain boost). Alternatively, if an HFI value for a particular location is less than a threshold value in a corresponding location in the threshold map 44, the corresponding location in the detail map 48 will indicate that the location should receive a negative boost. Finally, if an HFI value for a particular location is equal to a threshold value in a corresponding location in the threshold map 44, the corresponding location in the detail map 48 will indicate that the location requires no enhancement boost. In an exemplary embodiment, the detail map may be comprised of positive signs (+1) for those edges that need a positive boost, zero (0) for those edges that require no enhancement, and negative signs (−1) for those edges that require a negative boost. Values in the detail map 48 may be assigned to regions in any manner, e.g., on a pixel-by-pixel basis, block-by-block basis, etc.

After the detail map 48 is generated, a line elimination refinement 50 is applied to generate a fine detail map (FDM) 52. Line elimination refinement 50 reduces the amount of enhancement data by eliminating information that is not likely to contribute to the creation of a high definition feel. In an exemplary embodiment, the refinement 50 consists of eliminating lines and points (e.g., edge details) in the detail map 48 that stand at least N pixels away from each other (e.g., N=5). In this exemplary embodiment, refinement 50 will not significantly reduce the image quality since sharpness enhancement algorithms can readily emulate lost details if the thresholded lines or points stand far away. Obviously, other refinements could likewise be applied.

Next, motion compensation is used for the P and B frames 54. Finally, a binary compression 56, e.g., ZZIP™, is applied to compress the motion compensated FDM 52 to create E-data 58.

3. Playback System

During playback, the bitstream in the DVD can be decoded by any DVD compliant decoder in an SD format. In addition, for an HD-enabled decoder, the E-data (stored, e.g., as userdata) is retrieved and combined with the regular SD upconverted pictures via post-processing to create an image that can be displayed on an HD-ready TV with an HD “feel.”

In accordance with the VFDI system 23 described above, fine detail map 52 instructs the post-processor to specifically enhance critical locations (e.g., edges) within an image based on the different gains (e.g., −1, 0, +1) assigned to the different regions of the image. +1 means that the edge pixel needs a boost, zero means no enhancement, and −1 means the edge pixel needs a negative boost. During playback, an HD “feel” will be created when the fine details are added back to the upconverted SD picture based on the fine detail map 52 reconstructed from the E-data and local activity of the upconverted SD picture. During playback, the FDM 52 is uncompressed and values are applied by a playback system (FIG. 2) to restore HD effects on an upconverted SD picture. Furthermore, after adding back the fine details, any type of enhancement method may be utilized. Exemplary methods include adaptive peaking and/or LTI (Luminance Transient Improvement). In an exemplary embodiment, details are added back based on the detail map, and then adaptive peaking and/or LTI are applied.

Referring now to FIG. 2, a playback system 30 is shown for playing back image data stored on DVD 24. Playback system 30 comprises an MPEG decoder 32 for generating either a 60i progressive or 60i signal and a de-interlacer 34 for generating either a 30p or 60p signal. An upconversion and postprocessing system 36 receives the 30p or 60p signals, as well as the E-data, to generate HD 30p or HD 60p signals. A frame rate doubler or interlacer system 38 then generates either a 1080i or 720@ 60p output.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system (10) for providing high definition (HD) video images in a standard definition (SD) compatible format, comprising:
a system (12) for scaling down the HD video images to an SD video format;
a system (18) for encoding the SD video;
a system (22) for generating a fine detail map for each HD video image; and
a system (24) for storing the SD video and each fine detail map in the SD compatible format.

2. The system (10) of claim 1, wherein each fine detail map describes edge details in the HD video image.

3. The system (10) of claim 2, wherein the system (22) for generating the fine detail map includes:
a system for generating a threshold map having threshold values derived from a brightness level and an activity level of each region in the HD video image;
a system for comparing the threshold values to corresponding values in a high frequency image generated from the HD video image.

4. The system (10) of claim 3, wherein the system (22) for generating the fine detail map further includes a line reduction system that eliminates edge details that are greater than a predetermined distance away from other edge details.

5. The system (10) of claim 1, wherein the system (22) for generating the fine detail map comprises a compression system for compressing the fine detail map.

6. The system (10) of claim 1, wherein the fine detail map includes positive values indicating regions that require a positive boost, negative values indicating regions that require a negative boost, and zeros indicating regions that require no boost.

7. The system (10) of claim 1, wherein the system for encoding (18) comprises an MPEG-2 encoder, and the SD compatible medium comprises a DVD.

8. The system (10) of claim 1, wherein the SD video and the fine detail map are stored at a combined rate of approximately 5 megabits/second.

9. The system (10) of claim 1, wherein the fine detail map is stored at a rate of less than 1 megabit/second.

10. The system (10) of claim 1, further comprising an aspect ratio format system for formatting the SD video for widescreen, letterboxing, and scan and pan formats.

11. The system (10) of claim 1, wherein the SD video can be stored in a format selected from the group consisting of: progressive and interlaced.

12. The system (10) of claim 1, wherein the fine detail map is stored in an MPEG userdata field.

13. A playback system (30) for reconstructing a high definition (HD) video image from a standard definition (SD) format bitstream (24), comprising:
a system (32) for extracting and decoding SD data from the bitstream;
a system for extracting a fine detail map associated with each image from the bitstream;
a system (34) for de-interlacing the decoded SD data; and
a system (36) for up-scaling and post-processing the decoded SD data with the fine detail map to generate the HD video image.

14. The playback system (30) of claim 13, wherein the fine detail map comprises information relating to edge details extracted during a recording process.

15. The playback system (30) of claim 13, wherein the post-processing system (36) applies adaptive peaking after fine details have been added back to the video image using the fine detail map.

16. The playback system (30) of claim 13, wherein the post-processing system (36) applies luminance transient improvement after fine details have been added back to the video image using the fine detail map.

17. A method for recording high definition (HD) video images onto a standard definition (SD) compatible medium, comprising:
scaling down the HD video images to an SD video format;
encoding the SD video;
generating a fine detail map (52) for each HD video image, wherein the fine detail map describes edge details in each HD video image; and
storing the SD video and the fine detail map onto the SD compatible medium.

18. The method of claim 17, wherein the step of generating the fine detail map (52) includes:
extracting high frequency image data (42) from a HD video image (40);
creating a threshold map (44) having threshold values derived from a brightness level and an activity level of each region in the HD video image; and
comparing (46) the threshold values to corresponding high frequency image data.

19. The method of claim 18, wherein the step of generating the fine detail map (52) further includes assigning a positive value to regions having a threshold value lower than corresponding high frequency image data, a negative value to regions having a threshold value higher than corresponding high frequency image data, and zero to regions having a threshold value equal to corresponding high frequency image data.

20. The method of claim 18, wherein the threshold values are lower for pixel locations in a center region of the image relative to pixel locations at a periphery of the image.

21. The method of claim 18, wherein the step of generating the fine detail map includes the further step of eliminating edge details that are greater than a predetermined distance away from other edge details.

22. The method of claim 18, wherein the HD video image (40) comprises an I frame, and the step of generating the fine detail map includes performing motion compensation for P and B frames.

23. A method of reconstructing a high definition (HD) video image from a standard definition (SD) format recording, comprising:
extracting and decoding SD data from the recording;
extracting a fine detail map (52) from the recording, wherein the fine detail map describes edge details relative to an importance threshold;
de-interlacing the decoded SD data; and
up-scaling and post-processing the decoded SD data with the fine detail map (52) to generate the HD video image.

24. The method of claim 23, wherein the enhancement information is stored in an MPEG userdata field.

25. The method of claim 23, wherein the decoded SD data is post-processed by applying adaptive peaking after fine details have been added back to the HD video image using the fine detail map.

26. The method of claim 23, wherein the decoded SD data is post-processed by applying luminance transient improvement after fine details have been added back to the HD video image using the fine detail map.

27. A program product stored on a recordable medium for generating a fine detail map to allow (HD) video images to be stored and played back from a standard definition (SD) medium, comprising:
means (20) for extracting high frequency image data from a HD video image;
means (22) for creating a threshold map having threshold values derived from a brightness level and an activity level of each region in the HD video image; and
means for comparing the threshold values to corresponding high frequency image data.
